(19) United States
(12) Patent Application Publication
(10) Pub. No.: US 2004/0073144 A1
(43) Pub. Date: Apr. 15, 2004

(54) Devices and methods for applying negative pressure to body surfaces

(76) Inventor: Alma Delia Carava, Santa Cruz, CA (US)

Correspondence Address: BOZICEVIC, FIELD & FRANCIS LLP, 200 MIDDLEFIELD RD, SUITE 200, MENLO PARK, CA, 94025, US

(21) Appl. No.: 10/271,357

(22) Filed: Oct. 11, 2002

(51) Int. Cl. A61H 9/00; A61H 23/00

(52) U.S. Cl. 601/6

(57) ABSTRACT

Devices, systems and methods for applying suction to body surfaces are provided. The subject devices and systems provide various configurations of suction applicators for applying a suction force to a selected area skin. The methods involve the use of the subject devices and systems to treat the selected skin area.

### FIELD OF THE INVENTION

The present invention generally relates to suction devices for the aesthetic and therapeutic treatment of the skin, the scalp and body tissue.

### BACKGROUND OF THE INVENTION

The human skin and subdermal tissue can experience temporary or long term changes and conditions that affect the aesthetics and health of the skin and tissue. Such effects are especially noticeable in the areas of the face, neck and scalp, but also in other areas of the body. Such changes and conditions may be due to aging, metabolic and hormonal fluctuations (e.g., during puberty and menopause), illness, stress, sun exposure, weight gain, smoking, alcohol consumption, etc.

Pneumatic therapies and devices have been developed to treat the skin and subdermal tissues to enhance the appearance and health of body tissue and particularly the skin and tissue of the face, neck and scalp. One such therapy, disclosed in U.S. Pat. No. 3,841,332, employs cup-like applicators which are adhered to the skin by means of a variable pulsating vacuum device and caused to apply a cyclical suction-relaxation action to the skin. The patent promotes this therapy as improving lymphatic and blood circulation in the areas of suction application. A similar apparatus is disclosed in U.S. Pat. No. 6,319,211 which also employs suction to aesthetically treat the face. The device has a nozzle to which a tubular attachment or applicator is coupled for applying the suction to the face to remove dirt and debris. The device further includes a regulator which regulates the amount of suction force being applied. U.S. Pat. No. 5,377,701 describes a sucking massage device for beauty treatments which includes sucking lips in the configuration of a gyrorotor which are movable in a manner to allow the negative pressure to smoothly change within a limited range. This configuration prevents sliding movement of the sucking lips relative to the skin and maintains a constant maximum sucking force on the skin.

While these known suction-based skin massagers and aesthetic treatment devices provide benefits to the subject being treated, there is still a continued interest in the refinement of such devices, making them easier to use, more versatile, as well as safer and more efficacious.

### SUMMARY OF THE INVENTION

The present invention includes devices, systems and methods which involve the use of suction to massage the skin and tissue to provide beneficial effects. The beneficial effects may include, but are not limited to, the removal of dead skin cells and dirt, unclogging pores, increasing collagen production within the skin thereby firming the skin, increasing oxygenation of epidermal surfaces, increasing blood circulation within the skin thereby enhancing production of skin cells, flushing excess lymph fluid from surrounding tissue thereby minimizing puffiness, and/or detoxification of the lymphatic system.

The systems of the present invention include a portable unit which provides a source of suction which is directed by means of a hand-held or hand-worn device to the skin of the face and/or body of a subject being treated. The system includes various sizes and shapes of suction attachment heads or applicators which are attachable to the wand. The system also provides various levels of suction pressure which may be applied to the skin. The particular suction applicator used as well as the level of suction employed are selected by the user depending on the application at hand. In one embodiment, the system is particularly configured for the application of suction to the face and neck wherein the hand-held device is a wand to which suction applicators may be interchangeably attached. In another embodiment, the system includes a hand-worn flexible webbing or sheet of material which is especially useful in treating the scalp. The subject methods involve applying a selected amount of suction force for a period of time to a selected area of the skin with a selected suction attachment head.

### BRIEF DESCRIPTION OF THE FIGURES

To facilitate understanding of the invention, the same reference numerals have been used (where practical) to designate similar elements that are common to the Figures. Certain aspects of the Figures provide a diagrammatic representation the present invention, while others are indicative of preferred configurations. Regardless, variation of the invention from what is shown in the Figures is contemplated.

FIG. 1A shows an embodiment of a suction application system of the present invention.

FIG. 1B illustrates a control panel of the system of FIG. 1A providing a plurality of suction levels which may be selected by the user.

FIG. 2A-2G illustrates various embodiments of suction cups for attachment to the distal end of the wands of the present invention.

FIG. 3A illustrates an embodiment of a wand of the system of FIG. 1A.

FIG. 3B shows a filter component of the wand of FIG. 3A.

FIG. 3C the distal end of an embodiment of a wand of the present invention which provides for the delivery of a fluid to the skin surface.

FIG. 4 illustrates a mechanism for coupling a suction cup of the present invention to the distal end of a wand of the present invention.

FIG. 5A illustrates a bottom plan view of an embodiment of the present invention useful for scalp applications.

FIG. 5B illustrates a top view of the embodiment of FIG. 5A.

FIG. 5C illustrates a top view of the embodiment of FIGS. 5A and 5B operatively worn on the hand of a user.

FIG. 6 is a block diagram of the internal components of the system of FIG. 1A.

### DETAILED DESCRIPTION OF PREFERRED EMBODIMENTS

Before the present invention is described in such detail, it is to be understood that this invention is not limited to particular variations set forth herein as various changes or modifications may be made to the invention described and equivalents may be substituted without departing from the true spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

In further describing the subject invention, the subject devices and systems will be described first followed by a description of the subject methods and a summary of the kits which include the subject devices for performing the subject methods.

### Devices and Systems

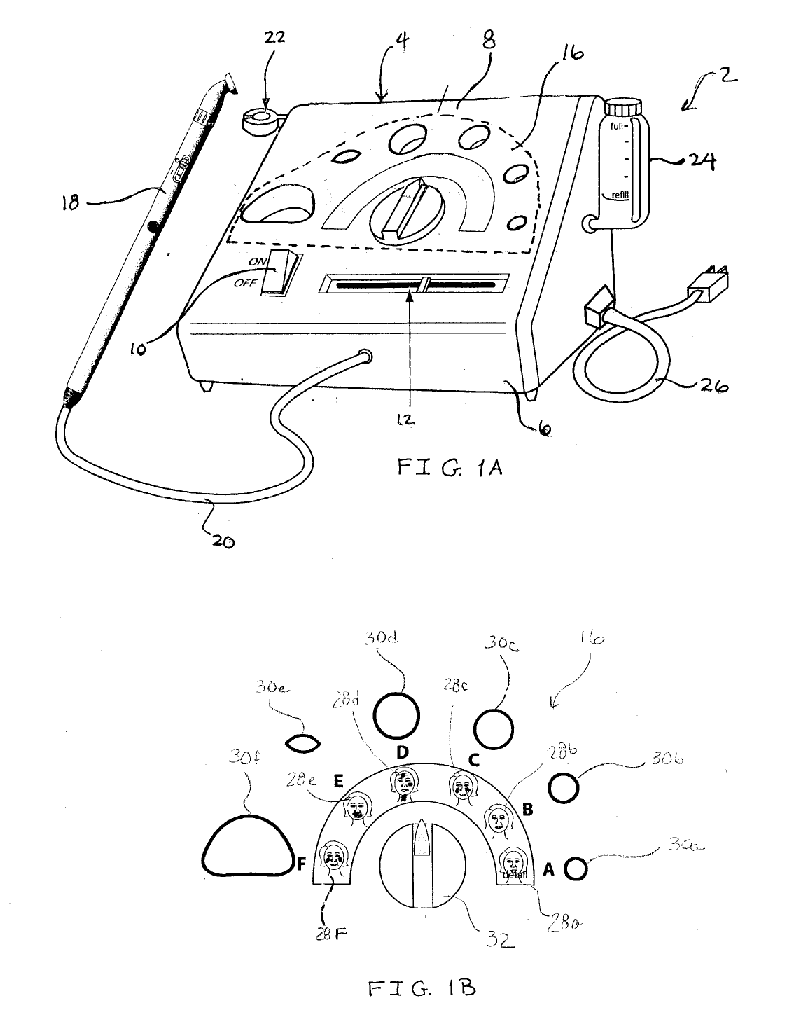

Referring now to FIG. 1A, there is shown a system 2 of the present invention for applying a suction force to the skin. System 2 includes a suction supply and control unit 4 having a housing 6. Housing 6 is preferably sized so as to be portable but may have any suitable dimensions for the context of use. Typical dimensions might include a height of about 12 inches, a side-to-side length of about 12 inches and a width of about 8 inches. The portability of the system allows for home use either by a licensed aesthetician or by the subject himself/herself.

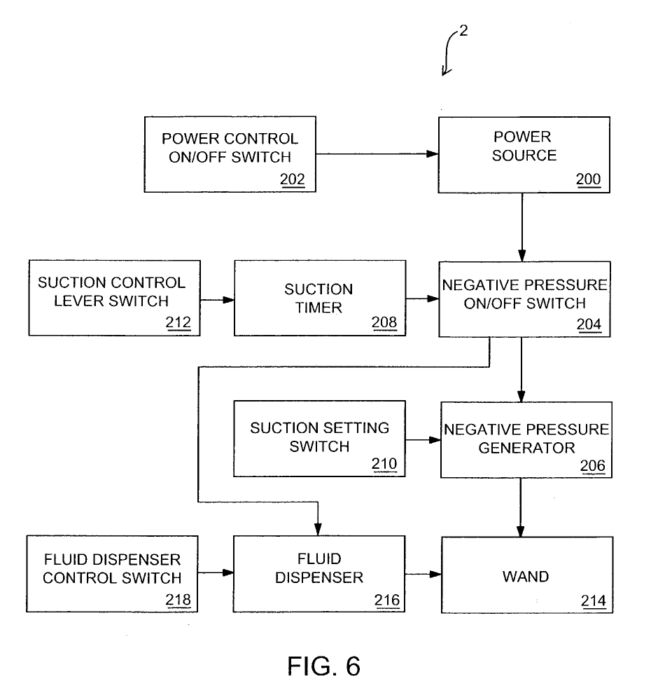

Contained within housing 6 is a negative pressure generator or pump which provides a source of suction, a motor for driving the pump, and other components which are discussed in greater detail below with respect to FIG. 6. The negative pressure generator or pump may be any suitable pump mechanism including, but not limited to, a bellow pump, a diaphragm pump, a centrifugal pump, a gear pump, a magnetic drive pump, a vacuum pump, etc. While system 2 may be battery powered, an electrical cord 26 is provided for connection to a source of electrical power in order to charge the battery and/or provide direct power to the system.

The system further includes a hand-held suction wand 18 which includes a suction port (not shown) at a distal end thereof for directing and applying suction. Negative pressure is supplied to a pathway within wand 18 in fluid communication with a tubing 20 which is operatively coupled to the negative pressure generator within housing 6. A holder 22 is also provided for holding wand 18 when not in use.

System 2 optionally provides for the application of a fluid, such as one or more essential oils, from a fluid container or dispenser 24 which is in fluid communication with a tubular line (not shown) which may extend coaxially or in parallel with tubing 20 and into wand 18. The system may be configured such that the application of fluid is controlled by the same pump used to provide the negative pressure or may be controlled by a separate dedicated pump. Container 24 may be provided with graded markings so that the user may determine how much fluid has been used and how much is remaining.

A control panel 8 is provided on the front or top side of housing 6. The control panel includes a power control (on/off) switch 10, a timer control lever 12 used to set the desired duration of suction application and suction level control settings 16. Suction control settings panel 16 is separately illustrated in FIG. 1B. A plurality of suction settings 28a-f are provided, here arranged in a semicircular array about a setting dial 32. Settings 28a-f provide graded or different levels of suction force wherein each level setting provides a substantially optimal suction force for a selected application. Optionally, settings 28a-f may be identified by icons or emblems which indicate the part of the face or body to which the selected suction level is suitable. These iconographic markings aid in ensuring that the user selects the proper suction level for the area of skin being treated thereby minimizing the risk of applying suction at a level which is painful and/or bruising to the area being treated. Here, for example, settings 28a and 28b are relatively low settings which are useful for detail work particularly on the face. Setting 28c provides a slightly higher level of suction force which is appropriate, as indicated by the associated emblem, for areas around the nose and mouth. Setting 28d provides an even greater level of suction which is appropriate, as indicated by the associated emblem, for areas on the forehead, cheeks and neck. Setting 28e provides an appropriate suction force for treating the lips and areas adjacent thereto. Setting 28f may provide a suction level that is appropriate for larger or less delicate areas of the body or face, as well as to promote sinus relief. While particular applications are illustrated, many other applications, such as scalp and body treatments, are contemplated. Generally, system 2 provides for suction forces, i.e., negative pressures, in the range from about 3.5 psi to about 8.0 psi, and more particularly in the range from about 3.5 psi to about 6.5 psi for facial applications and typically from about 6.5 psi to about 8.0 psi for areas of the body other than the face.

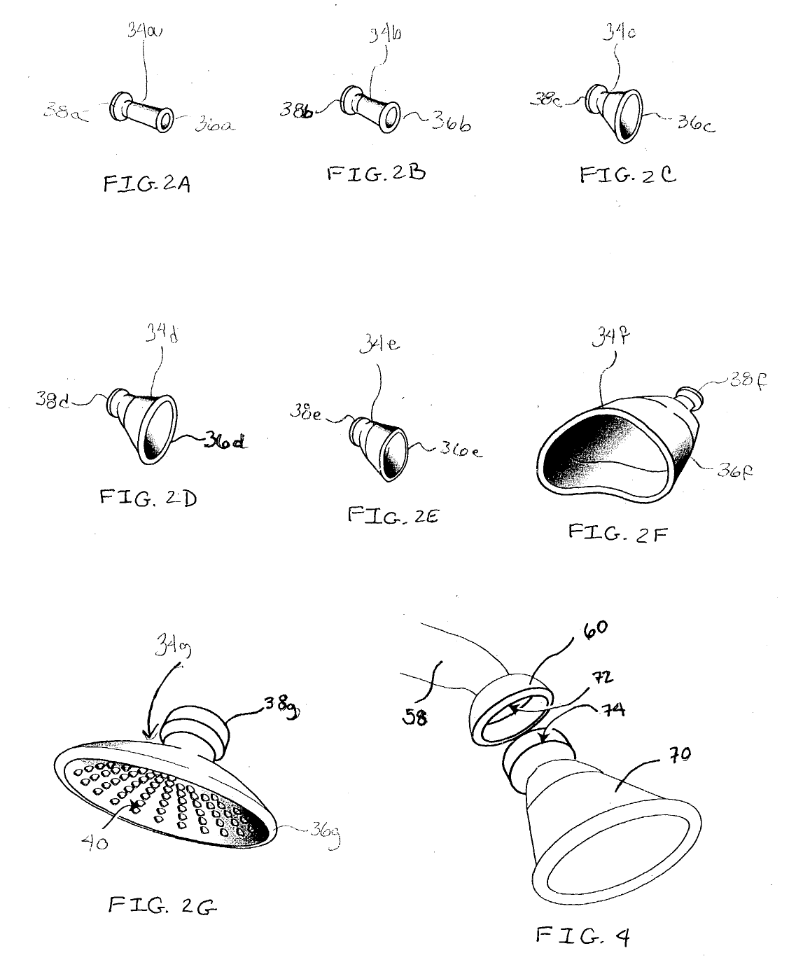

An attachment or applicator holder, socket or receptacle 30a-f within control panel 8 may be provided in correspondence with each setting 28a-f. Each receptacle 30 preferably has a shape that matches that of a corresponding suction cup or applicator or attachment head 34a-f of FIGS. 2A-2F. Each of the applicators has a tubular, conical, concave or cup configuration to define a negative pressure chamber when the open end is sealed against the skin. Each applicator head has a distal or skin contacting end 36a-f and a proximal or wand coupling end 38a-f. While the sizes and shapes of the applicators may vary, their proximal ends 38a-f are preferably identically configured so as to interchangeably couple with wand 18. The size and shape of the skin-contacting ends of the various applicators may depend on the shape, contouring and/or firmness of the area of skin being treated. For example, applicators 34a-d each have a circular or annular skin-contacting end 36a-d and, as indicated by their corresponding icons, are suitable for detail work on the face, neck, jaw and forehead. Attachment 34e of FIG. 2E has an almond-shaped or eye-shaped distal end 36e, which, as mentioned above, is suitable for treating the lip area or another highly contoured area. Distal end 36f of applicator 34f of FIG. 2F has a semi-circular or kidney bean shape and defines a suction area which is relatively larger than the other applicator heads just described. Such a size and shape is useful for areas above the sinus passages to promote sinus relief due to congestion.

Another relatively larger attachment head 34g is illustrated in FIG. 2G having an annular distal end 36g which provides a suction area which is substantially larger and suitable for locations on the body such as the arms, legs, hips abdomen, back and buttocks. Additionally, suction cup 34g may provide for protrusions or nodules 40 so as to further stimulate circulation within the massaged or suctioned region. Such feature may be particularly beneficial when used on the scalp in order to stimulate hair growth. Additionally, the edge, rim or lip of the distal end of any of the applicators may be provided with a material, such as a polymer or the like, that facilitates an air-tight seal with the skin.

System 2 provides for suction attachment heads sized to cover a skin surface area in the range from about 0.10 in² to about 1.5 in² for facial applications and greater about 1.5 in² for treating areas of the body other than the face. Generally, the larger the suction attachment or cup employed, the lower the level of suction force needed to achieve the intended therapeutic result. While only six suction level settings and corresponding emblems and suction attachments are employed with the system of FIG. 1A, such is intended to be exemplary and in no way limiting to the present invention, as any number of settings, emblems and applicators or attachments may be used. The overall one-to-one correspondence approach between setting levels and applicator heads and icons indicative of treatment protocols, however, form part of the invention.

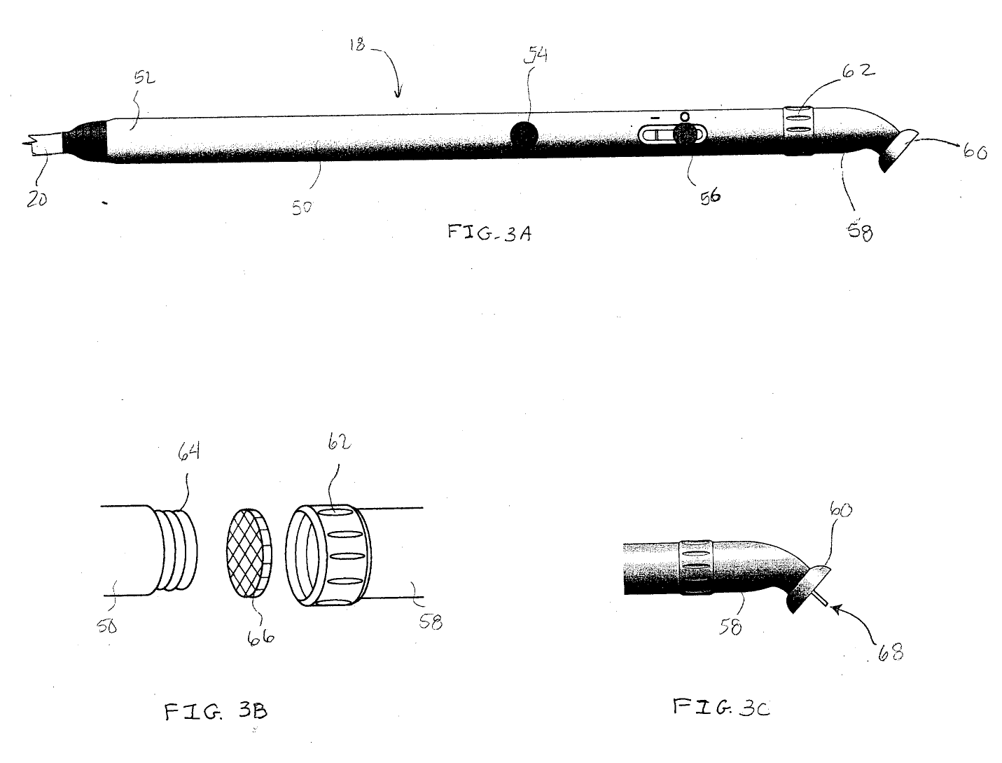

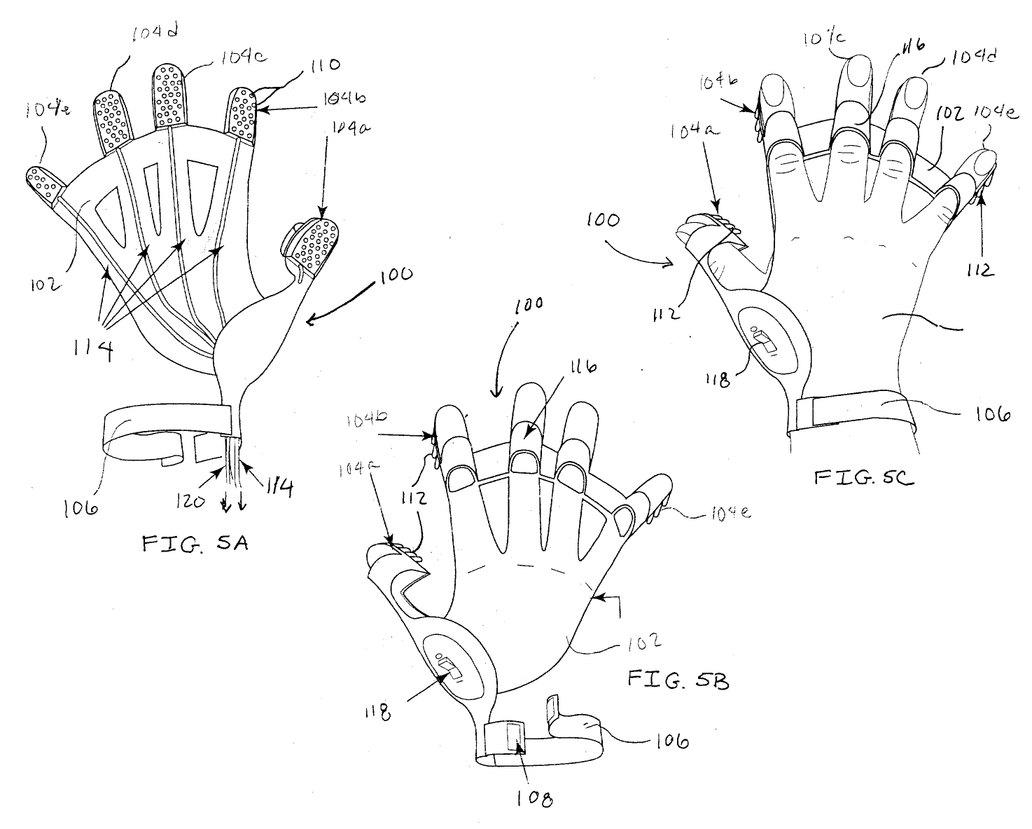

Referring now to FIG. 3A, an enlarged view of wand 18 of FIG. 1A is illustrated. Wand 18 has a shaft 50 which is attached at its proximal end 52 to suction tubing 20. Along the body of the shaft 50 is a suction pause switch 54 having a spring-release button configuration. Suction pause switch 54 functions to temporarily pause the application of suction as well as the system's timer. Distal to switch 52 on shaft 50 is a suction on/off switch 56 which also serves to restart the system's timer. At a distal end or head 58 of shaft 50 is a receptacle 60 for retaining the various suction attachments or applicators of the present invention. Distal end 58 may be slightly curved so as to facilitate application of suction.

As illustrated in FIG. 3B, a filter 66 may be positioned within the suction lumen of shaft 50 so as to collect dirt and debris, e.g., dead skin cells, removed from the skin. Shaft 50 may be configured to be separable at or near the location of 66 so that the filter such as by threaded end 64 of shaft 50 and threaded nut 62 so that filter 66 may be easily replaced.

As mentioned above, system 2 may be equipped to provide essential oils or the like to be applied to the target skin area during application of suction to help nourish the skin while facilitating the translation of the applicator over the surface of the skin. For this purpose, FIG. 3C illustrates a distal end 58 of a wand configured with a fluid dispenser 68 for optimally applying oil while suction is applied. Fluid dispenser 68 is in fluid communication with container 24 of FIG. 1A via a tubing line (not shown) which extends between the two.

Optionally, receptacle 60 and the suction applicator heads of the present invention, such as applicator head 70, as illustrated in FIG. 4, may be configured such that suction applicator head 70 is automatically released from receptacle 60 when subject to a counter force. For example, receptacle 60 may be provided with a first magnetic coupler portion 72 and cup 70 may be provided with a second magnetic coupler portion 74 at its proximal end whereby first and second magnetic means have opposing polarities and are held together when placed in sufficient proximity of each other. When applicator cup 70 is subject to a counter or opposing force such as a pushing or pulling force which is greater than the magnetic force between first magnetic means 72 and second magnetic means 74, attachment cup 70 will be released thereby cutting off the suction force being applied to the skin. The release of attachment cup 70 and the cessation of application of suction to the skin occur prior to any pain and/or bruising is experienced by the subject.

Referring now to FIGS. 5A, 5B and 5C, there is illustrated another embodiment of a suction attachment of the present invention that is particularly useful for massaging and treating the scalp. Suction attachment 100 is configured somewhat like a glove to fit over the hands and fingers of a user, and is provided with a flexible, insulating webbing or sheet 102 of material having an area sized and contoured to fit over the hand. Webbing 102 may be made of any suitable material such as polyester, nylon or the like. At a proximal portion of webbing 102 is a wrist strap 106 that is adjustable in size such as by a Velcro strip 108. At the distal portions or edges of sheet 102 are a plurality of suction applicators 104a-e that are configured to attached or fit over the thumb and four fingers, respectively, by means of a finger loop 116. Each applicator 104a-e is configured to apply suction through either one or a plurality of suction holes or pores 110 which may be flush with the webbing 102. Alternatively, suction holes 110 may be provided within protrusions or nodule 112 or positioned between and about the protrusions 112. Within or attached to webbing 102 are vacuum or suction lines 114, one for each suction applicator 104a-e, which extend proximally and collectively through wrist strap 106 to suction and control unit 4 of FIG. 1A. A power switch 118 is provided at a convenient area on attachment 100, such as in the area of the thumb applicator 104a. Switch 118 is electrically connected via an electrical line 120 to a suction and control unit 4. An additional electrical line may be provided to control the application of suction to attachment 100. Further, the webbing may be provided with one or more fluid conducting lines for the delivery of fluids such as a hair growth formulation held within container 24 attached to control box 4.

Referring now to FIG. 6, there is shown a functional block diagram illustrating the components of system 2 in accordance with the present invention. As shown in FIG. 6, the system 2 includes a power source 200 such as a battery pack or a transformer, wherein the power source 200 is in communication with on/off switch 202 for controlling power source 200. Power source 200 provides power to negative pressure generator 206 via an on/off switch 204. The user controls the operation of negative pressure generator 206, including the suction application time and pressure, via timer 208 and suction setting switch 210, respectively, which are in operative communication with negative pressure generator 206. A suction control lever and/or switch 212 is coupled to timer 208 and is used to temporarily pause the application of suction and the advancement of the suction timer 208. Suction setting switch 210 may be utilized to control the amount of negative pressure applied through wand 214. The output of negative pressure generator 206 is supplied to wand 214 which may be provided with a valve (not shown) for manually adjusting the amount of suction applied through the wand. As mentioned above, system 2 may further include a fluid-dispensing device 216 in fluid communication with wand 214. The application of fluid from the dispensing device 216 may be controlled by means of a designated fluid dispenser control switch 218, and/or with the negative pressure on/off switch 204 thereby allowing the fluid dispensing device 216 to work in conjunction with the negative pressure generator 204. As mentioned above, the pump used to run the negative pressure generator 206 may also be used to pump fluid from dispenser 216 to wand 214. Alternatively, a separate dedicated pump (not shown) may be used to pump fluid from dispensing device 216 to wand 214.

### Methods

The methods of the present invention generally involve the use of suction to massage the skin and tissue to provide beneficial effects to the subject. The systems of the present invention may be used to carry out such methods to treat and massage the face, body and scalp. The systems may be used by a licensed practitioner, such as a medical doctor, massage therapist or aesthetician for treating another or may be used directly by the subject himself/herself for self-application. The subject methods are intended to cover varying techniques or suction application motions according to individual user preference.

In general, the subject methods involve the determination or selection of a target area of skin for treatment. Based on the selected target area and/or the objective of the treatment, e.g., removal of dirt, increased circulation, etc., a suitable level of suction force or negative pressure is selected. Also, a suitable suction applicator or attachment is selected for applying or directing the suction force to the target skin area. Where the application involves the face and neck, the user attaches a suction applicator or attachment head or cup to a wand, such as described above with respect to FIG. 3A. While the wand embodiment may also be used on areas of the scalp, the glove embodiment of FIGS. 5A-C provides a system particularly configured for treating the scalp. With the latter system, the user dawns or fits the applicator glove over his or her hand in preparation for use.

The level of suction force is selected by the user. While the selector dial of the system of FIG. 1A provides for easy selection of a suction level corresponding to the applicator selected, the user may choose to use a suction level that is greater or less than the corresponding suction level. The user may also preselect the duration for application of the suction where the suction force is automatically turned off when the preselected period expires. This is done by activating the timer by means of timer level 12 on the suction control box 4 or by means of suction control switch 54 on the wand haft 50. Alternatively, the duration of suction application may be left to the user's discretion.

Once the desired settings are selected, the suction force is turned on and the user then operatively handles the applicator and contacts the applicator to the target skin area. A lubricant may first be applied to the skin or to the applicator head prior to applying the applicator head to the skin. The applicator is drawn or traversed across the target skin surface using motions according to user preference or prescribed protocol. Typically, this involves drawing the applicator head across the skin a direction of the lymph glands or nodes so as to promote the drainage of toxins. The application of suction may be terminated automatically prior to expiration of the selected application cycle if the suction applicator is subject to a predetermined force. Prior to, throughout or intermittently throughout the application of suction, a fluid, such as an essential oil or hair growth formulations, may be applied to the target skin area via fluid pathway in the wand or glove.

The process just described may be repeated on the same target area as many times as desired or as necessary. Further, the process may be replicated for one or more other target skin areas wherein the suction applicator head is interchanged with another more suitable applicator head and the level of suction force may be adjusted for each particular target skin area to be treated.

### Kits

Also provided are kits that include the system as described above having a selection, panel or plurality of suction applicators having varying sizes and shapes for optimizing the application of suction to a particular skin area. The kits may further include containers of various essential oils or the like as well as a plurality of disposable wand filters.

In addition, the subject kits typically include instructions for using the subject systems in methods according to the subject invention. The instructions for practicing the subject methods are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g., via the Internet, are provided. An example of this embodiment is a kit that includes a web address where the instructions can be viewed and/or from which the instructions can be downloaded. As with the instructions, this means for obtaining the instructions is recorded on a suitable substrate.

It is evident from the above description that the subject invention provides devices, systems and methods of massaging and treating the skin which improve upon earlier devices. The subject devices and systems are easy to use, versatile and can be used in a variety of applications with a variety of differently configured suction applicators and at a varying negative pressure levels.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the present invention and the appended claims. That being said, what is claimed is:

1. A skin treatment system, comprising:
a source of negative pressure;
at least one suction applicator in communication with the negative pressure source, the applicator being configured for contacting a particular area of skin;
a plurality of suction levels associated with said source of suction;
a suction level selector associated with said plurality of suction levels; and
a panel of icons wherein each icon is associated with a desired treatment protocol.

2. The skin treatment system of claim 1, further comprising:
a plurality of suction applicators configured to be coupled to the suction source, each applicator having a unique configuration or size.

3. The skin treatment system of claim 2, wherein each icon is associated with a suction level and with a suction applicator.

4. The skin treatment system of claim 2 further comprising a housing in which the source of suction is housed and on which the plurality of suction applicators, the suction level selector and the panel of icons are selectively provided.

5. The skin treatment system of claim 4 wherein the housing provides a plurality of receptacles wherein each said receptacle is configured to selectively hold a single corresponding suction applicator.

6. The skin treatment system of claim 2 wherein at least one of said plurality of suction applicators comprises skin-contacting protrusions.

7. A skin treatment system, comprising:
a source of suction;
a plurality of suction applicators, each applicator having a unique configuration or size;
a wand in fluid communication with said source of suction and configured to couple with each of said plurality of suction applicators;
a plurality of suction levels associated with said source of suction;
a suction level selector associated with said plurality of suction levels; and
a panel of icons wherein each icon is associated with a suction level and with a suction applicator.

8. The skin treatment system of claim 7 further comprising a fluid container in fluid communication with the wand.

9. The skin treatment system of claim 8 wherein said fluid container contains an essential oil.

10. The skin treatment system of claim 7 further comprising a timer for timing the application of suction.

11. The skin treatment system of claim 7 wherein at least one suction applicator has a circular configuration.

12. The skin treatment system of claim 7 wherein at least one suction applicator has an almond-shaped configuration.

13. The skin treatment system of claim 7 wherein at least one suction applicator has an kidney bean-shaped configuration.

14. A skin treatment system, comprising:
a source of suction;
a flexible webbing configured to be worn on the hand and having at least one suction port associated with a portion of the flexible webbing associated with each finger; and
a suction line extending between the source of suction and the at least one suction port.

15. The skin treatment system of claim 14 further comprising a plurality of nodules extending from said flexible webbing and associated with the at least one suction port.

16. The skin treatment system of claim 14 further comprising a plurality of suction ports associated with each finger portion of the flexible webbing.

17. A method of treating the skin, comprising:
determining an area of skin to be treated;
selecting a suction applicator from a plurality of suction applicators and selecting a suction level from a plurality of suction levels wherein each applicator/suction level pairing is identified by an icon indicating a particular area of skin; and
applying suction to the determined skin area with the selected suction applicator at the selected suction level.

18. The method of claim 17 wherein the suction is applied for a preselected time period.

19. The method of claim 17 the application of suction is terminated when a predefined counter force is applied to the suction applicator.

20. The method of claim 17 further comprising:
determining a second area of skin to be treated;
selecting a second suction applicator from the plurality of suction applicators and selecting a second suction level from the plurality of suction levels; and
applying suction to the second determined skin area with the second suction applicator at the second selected suction level.

21. The method of claim 17 wherein said determined area of skin is on one of the group consisting of the face, neck, lips, scalp and body.

22. The method of claim 17 further comprising applying a fluid to the determined area of skin.

23. The method of claim 17 further comprising contacting the determined area of skin with a plurality of protrusions.
